(19) United States
(12) Patent Application Publication
(10) Pub. No.: US 2019/0359466 A1
(43) Pub. Date: Nov. 28, 2019

(54) CONVERTIBLE FUNNEL

(71) Applicant: Eugene L Ten Brink, Columbus, OH (US)

(72) Inventor: Eugene L Ten Brink, Columbus, OH (US)

(21) Appl. No.: 15/986,038

(22) Filed: May 22, 2018

(51) Int. Cl. B67C 11/02

(52) U.S. Cl. CPC B67C 11/02

(57) ABSTRACT

A flat piece of material in a predetermined shape convertible to a funnel, the flat piece of material comprised of an outer edge, a hole in the middle of the flat piece of material, a line cut from the hole to the outer edge, a first tab on a first side of the line and a second tab on a second side of the line, a first notch in the first tab, a second notch in the second tab, and where the flat piece of material is adapted to be converted into a funnel by moving the first and second tab portions in opposite directions and interlocking the first and second notches. To disassemble the funnel back to the flat shape, the tabs are unhooked from each other allowing the funnel to spring back, or relax, into the original flat piece of material. In the flat state, the material is much easier to clean and can be stored easily without taking as much space when compared to the funnel shape.

### CROSS-REFERENCE TO RELATED APPLICATION

This application is a nonprovisional patent application and makes no priority claim.

### BACKGROUND OF THE INVENTIVE FIELD

In one embodiment of the invention, the present invention is comprised of a flat, flexible, piece of material that is adapted to be constructed into a funnel.

The funnel of the present invention can be used to transfer, fluidic or granular or similar material from first container to a second container. The reusable funnel comprises a resilient, planar plastic material, with sufficient flexibility to be hand rolled.

Once the funnel is constructed, it is inserted into one container, and fluidic or granular material provided in a second container, is transferred through the use of the funnel, all while being held in place by the funnel's constructed handle.

Once the transfer has been completed, the funnel can be disassembled and returned to its original flat state, where it becomes easy to clean. In the disassembled and flat state, the flat piece of material can be stored easily and takes up less space than the constructed funnel.

### SUMMARY OF THE GENERAL INVENTIVE CONCEPT

In one embodiment of the invention, the invention is comprised of:

a flat piece of material in a predetermined shape, the flat piece of material comprised of: an outer edge, a hole in the middle of the flat piece of material, a line cut from the hole to the outer edge; a first tab on a first side of the line; a second tab on a second side of the line; a first notch in the first tab; a second notch in the second tab; and wherein the flat piece of material is adapted to be converted into a funnel by moving the first and second tab portions in opposite directions and interlocking the first and second notches; wherein the tabs extend out beyond the outer edge and are adapted to be grabbed by a user; and wherein the tabs in the interlocked position can be used as a handle for the funnel.

The foregoing and other features and advantages of the present invention will be apparent from the following more detailed description of the particular embodiments, as illustrated in the accompanying drawings.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 illustrates a plan view of one embodiment of the convertible funnel of the present invention;

FIG. 2 illustrates a side view of the convertible funnel of FIG. 1;

FIG. 3 illustrates the convertible funnel in the process of converting from a flat piece of material to a funnel;

FIG. 4 illustrates the convertible funnel in the constructed funnel stage when the notches in the tabs are interlocked with each other;

FIG. 5 illustrates a top view of the funnel of FIG. 4;

FIG. 6 illustrates another view of the constructed funnel of FIG. 4.

### DETAILED DESCRIPTION OF EXEMPLARY EMBODIMENT(S)

The following detailed description of the example embodiments refers to the accompanying figures that form a part thereof. The detailed description provides explanations by way of exemplary embodiments. It is to be understood that other embodiments may be used having mechanical changes that incorporate the scope of the present invention without departing from the spirit of the invention.

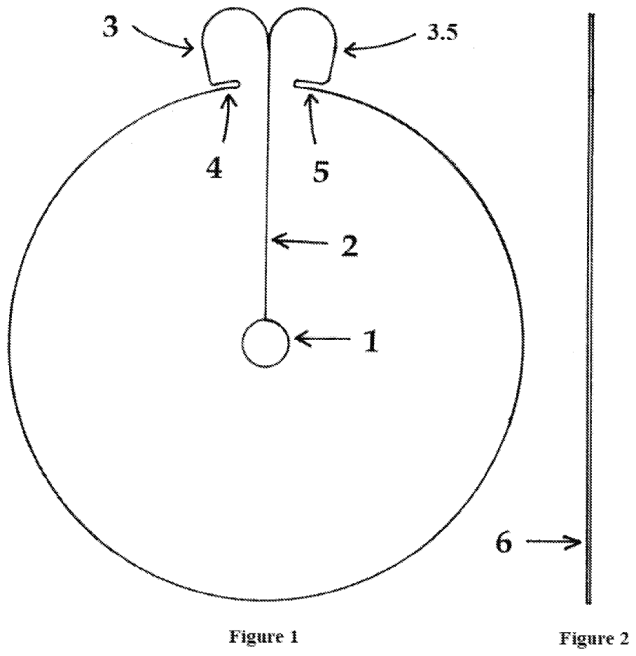

FIG. 1 illustrates a plan view of one embodiment of the convertible funnel of the present invention. FIG. 2 illustrates a side view of the convertible funnel of FIG. 1. In the preferred embodiment, the present invention is comprised of a flat piece of material in a predetermined shape, the flat piece of material comprised of: an outer edge, a hole 1 in the middle of the flat piece of material, a line 2 cut from the hole to the outer edge 6, and a first tab 3 on a first side of the line and a second tab 3.5 on a second side of the line, a first notch 4 in the first tab, a second notch 5 in the second tab, wherein the flat piece of material is adapted to be converted into a funnel by moving the first and second tab portions in opposite directions and interlocking the first and second notches.

In the preferred embodiment, the tabs extend out beyond the outer edge and are adapted to be grabbed by a user. As illustrated in FIG. 1, the first notch is cut out on the left side of the first tab; and the second notch is cut out on the right side of the second tab.

In the preferred embodiment, the flat piece of material is made from a durable and flexible plastic material. The material should be flexible to allow the flat piece of material to be bent and moved into a funnel shape but rigid enough to stay in the funnel shape for use. In one embodiment, the flat piece of material is 20 millimeters thick.

In the preferred embodiment, the flat piece of material is a circular shape with a circular hole in the middle. It is appreciated that the flat piece of material can also be made from other shapes, such as an oval, square or rectangle.

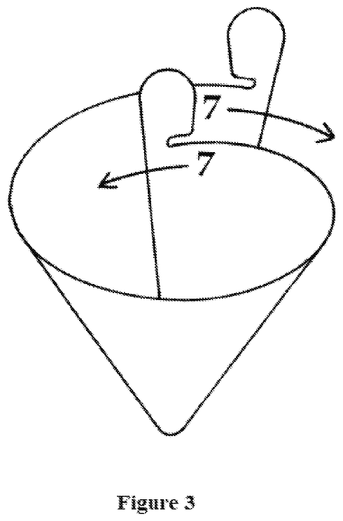

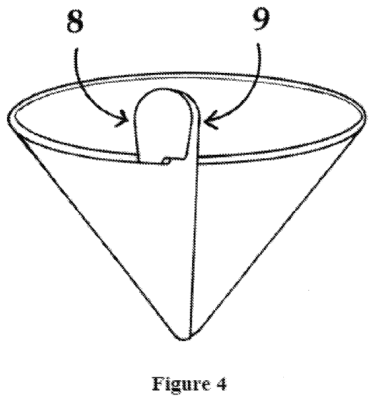

FIG. 3 illustrates the convertible funnel in the process of converting from a flat piece of material to a funnel. As illustrated, a user can grab the first and second notches of the flat piece of material and pull the tabs past each other in opposite directions (as shown by arrows 7). When the tabs meet on the opposite side, the tabs can be interlocked via the first and second notches to lock the tabs together and maintaining the material in the funnel shape. FIG. 4 illustrates the convertible funnel in the constructed funnel stage when the notches in the tabs are interlocked with each other. The rigidity of the rolled plastic reinforces the locked tabs, and maintains the funnel in a tight locked position until the tabs are disengaged. The tabs in the interlocked position can be used as a handle for the funnel.

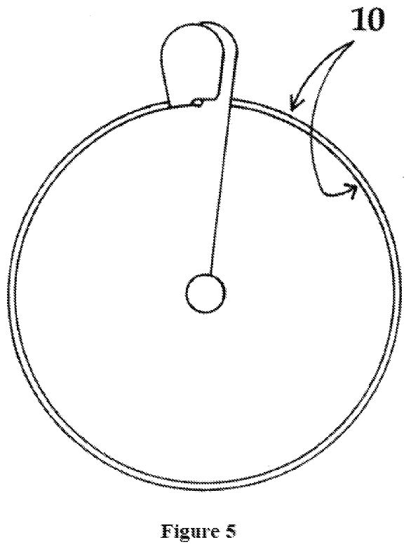

FIG. 5 illustrates a top view of the funnel of FIG. 4. In the preferred embodiment, when the tabs are in the interlocked position, the flat piece of material overlaps each other to form a double side layer 10 of the funnel as illustrated. This double side layer helps to maintain the funnel in a rigid position during use.

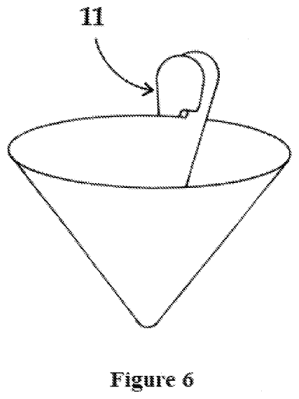

FIG. 6 illustrates another view of the constructed funnel of FIG. 4. To disassemble the funnel back to the flat shape, the tabs 11 are unhooked from each other allowing the funnel to spring back, or relax, into the original flat piece of material. In the flat state, the material is much easier to clean and can be stored easily without taking as much space when compared to the funnel shape.

While certain embodiments of the present invention are described in detail above, the scope of the invention is not to be considered limited by such disclosure, and modifications are possible without departing from the spirit of the invention as evidenced by the following claims:

What is claimed is:

1. A flat piece of predetermined material convertible into a funnel, comprising:
a flat piece of material in a predetermined shape, the flat piece of material comprised of: an outer edge, a hole in the middle of the flat piece of material, a line cut from the hole to the outer edge;
a first tab on a first side of the line;
a second tab on a second side of the line;
a first notch in the first tab;
a second notch in the second tab; and
wherein the flat piece of material is adapted to be converted into a funnel by moving the first and second tab portions in opposite directions and interlocking the first and second notches.

2. The apparatus of claim 1, wherein the tabs extend out beyond the outer edge and are adapted to be grabbed by a user.

3. The apparatus of claim 1, wherein the first notch is cut out on the left side of the first tab; and wherein the second notch is cut out on the right side of the second tab.

4. The apparatus of claim 1, wherein the flat piece of material is made from a durable and flexible plastic material.

5. The apparatus of claim 1, wherein the flat piece of material is circular in shape.

6. The apparatus of claim 1, wherein the flat piece of material is oval in shape.

7. The apparatus of claim 1, wherein the flat piece of material is square in shape.

8. The apparatus of claim 1, wherein the interlocked tabs maintain the flat piece of material in a funnel shape.

9. The apparatus of claim 1, wherein the tabs in the interlocked position can be used as a handle for the funnel.

10. A flat piece of predetermined material convertible into a funnel, comprising:
a flat piece of material in a circular shape, the flat piece of material comprised of: an outer edge, a hole in the middle of the flat piece of material, a line cut from the hole to the outer edge;
a first tab on a first side of the line;
a second tab on a second side of the line;
a first notch in the first tab;
a second notch in the second tab; and
wherein the flat piece of material is adapted to be converted into a funnel by moving the first and second tab portions in opposite directions and interlocking the first and second notches.

11. The apparatus of claim 10, wherein the tabs extend out beyond the outer edge and are adapted to be grabbed by a user.

12. The apparatus of claim 10, wherein the first notch is cut out on the left side of the first tab; and wherein the second notch is cut out on the right side of the second tab.

13. The apparatus of claim 10, wherein the flat piece of material is made from a durable and flexible plastic material.

14. The apparatus of claim 10, wherein the interlocked tabs maintain the flat piece of material in a funnel shape.

15. The apparatus of claim 10, wherein the tabs in the interlocked position can be used as a handle for the funnel.

16. The apparatus of claim 10, wherein the hole is a circular shaped hole.

17. A flat piece of predetermined material convertible into a funnel, comprising:
a flat piece of material in a predetermined shape, the flat piece of material comprised of: an outer edge, a hole in the middle of the flat piece of material, a line cut from the hole to the outer edge;
a first tab on a first side of the line;
a second tab on a second side of the line;
a first notch in the first tab;
a second notch in the second tab; and
wherein the flat piece of material is adapted to be converted into a funnel by moving the first and second tab portions in opposite directions and interlocking the first and second notches;
wherein the tabs extend out beyond the outer edge and are adapted to be grabbed by a user; and
wherein the tabs in the interlocked position can be used as a handle for the funnel.

18. The apparatus of claim 17, wherein the first notch is cut out on the left side of the first tab; and wherein the second notch is cut out on the right side of the second tab.

19. The apparatus of claim 17, wherein the flat piece of material is made from a durable and flexible plastic material.

20. The apparatus of claim 17, wherein the interlocked tabs maintain the flat piece of material in a funnel shape.

21. The apparatus of claim 17, wherein the hole is a circular shaped hole.

22. The apparatus of claim 17, wherein the predetermined shape is a circular shape.

23. The apparatus of claim 17, wherein the first and second notches are hooks.
